(19) United States
(12) Patent Application Publication
(10) Pub. No.: US 2019/0203863 A1
(43) Pub. Date: Jul. 4, 2019

(54) HYDRAULIC CONNECTING PART AND COUNTERPART FOR A QUICK CONNECTOR

(71) Applicant: KNORR-BREMSE SYSTEME FUER NUTZFAHRZEUGE GMBH, Muenchen (DE)

(72) Inventors: Bernhard Miller, Weil der Stadt (DE); Falk Hecker, Markgroeningen (DE)

(21) Appl. No.: 16/325,660

(22) PCT Filed: Aug. 8, 2017
(86) PCT No.: PCT/EP2017/070114

§ 371 Date: Feb. 14, 2019

(30) Foreign Application Priority Data
Aug. 19, 2016 (DE) 10 2016 115 389.3

(51) Int. Cl. F16L 29/00; F16L 29/04

(52) U.S. Cl. CPC F16L 29/005; F16L 2201/80; F16L 29/04

(57) ABSTRACT

A hydraulic connecting part for connecting to a hydraulic counterpart to form a hydraulic flow path between the hydraulic connecting part and the counterpart, including: a hydraulic connecting duct having a connection opening which faces the counterpart during the connection; a closure for the connection opening to keep a hydraulic liquid in the hydraulic connecting duct at a minimum pressure; and a fastening arrangement to fasten the connecting part to the counterpart.

### FIELD OF THE INVENTION

The present invention relates to a hydraulic connecting part, to a hydraulic counterpart, to a hydraulic connection and in particular to a quick mounting of electrohydraulic components by a quick connector.

### BACKGROUND INFORMATION

In vehicles, and in particular in commercial vehicles, many hydraulic components (for example hydraulic module, steering gear, components of the brake system, etc.) have to be connected to one another. In order to connect the components to one another, use is frequently made of pipelines or hose lines, but these have to be connected to one another quickly and reliably—even if only a limited installation space is available. This is the case in particular in commercial vehicles in which, as for example in the installation space of a steering gear, there is frequently only little space available, and therefore additional components for activating the exemplary steering gear generally have to be placed at another point in the engine compartment.

A further problem consists in the fact that hydraulic lines or pipes are frequently dirt-sensitive, which means that care has to be taken when forming the hydraulic connection to ensure that no dirt gets into the hydraulic connecting ducts. Conventional hydraulic connections are therefore formed in a correspondingly protected surroundings and, after the hydraulic connecting lines have been assembled in the final assembly stage of the vehicle, filled with hydraulic oil, for example. However, this has the disadvantage that the entire system still has to be vented.

There is thus a need for alternative hydraulic connections which can be formed quickly and securely, even in a confined installation space, and which offer reliable protection from contamination and as far as possible prevent air entry into the hydraulic duct during coupling of the components.

### SUMMARY OF THE INVENTION

The aforementioned technical object may be achieved by a hydraulic connecting part as described herein, a hydraulic counterpart as described herein and a hydraulic quick connector as described herein.

The invention relates to a hydraulic connecting part for connecting to a hydraulic counterpart in order to produce or provide a hydraulic flow path between the hydraulic connecting part and the counterpart. The connecting part comprises a hydraulic connecting duct, a closure and a fastening arrangement. The connecting duct comprises a connection opening which faces the counterpart during the connection. The closure is formed on the connection opening and suitable to keep a hydraulic liquid in the hydraulic connecting duct at a minimum pressure. The fastening arrangement is configured to fasten the connecting part to the counterpart.

The connecting part and the counterpart thus together form a hydraulic connector (or quick connector) which produces a hydraulic connection by bringing together (for example plugging together or screwing together) the two parts, wherein the hydraulic flow path is automatically opened during the bringing-together. Therefore, in further exemplary embodiments, the opening arrangement are configured to open the closure during the connection of the connecting part to the counterpart and thereby to form the hydraulic flow path.

In further exemplary embodiments, the closure comprises a covering (for example a metal foil or a sheet metal cover) and a sliding element, wherein the sliding element is pretensioned by a first spring element in order thereby to ensure an interspace between the opening arrangement and the covering and in order to sever the covering by way of the opening arrangement during a displacement of the sliding element counter to the spring tension.

In further exemplary embodiments, the hydraulic connecting duct is formed within a tubular portion, wherein the sliding element is arranged so as to be displaceable along an outer surface of the tubular portion. The opening arrangement additionally comprise one or more cutting blades which are formed at one end in the direction of the connection opening of the tubular portion in the hydraulic flow path. Here, the cutting blades do not block the hydraulic flow, but rather expose openings through which the hydraulic liquid can flow freely. In a cross-sectional view of the hydraulic flow path, the cutting blades can extend between an inner surface of the tubular portion. In addition, they can, for example, taper conically in the direction of the connection opening and have a sharp edge in this direction that makes it easier to sever the exemplary covering in order thus to form the flow path. Here, the term cutting blade is intended to be interpreted broadly and to comprise not only metal cutters but all arrangements which have a sufficiently sharp edge in order to be able to easily sever the closure or the covering (for example a metal foil).

In further exemplary embodiments, the sliding element is of cylindrical design and comprises a groove having a first annular sealing element along the outer circumference in order to allow sealing between the counterpart, into which it is partially inserted, and the connecting part after the connection.

Optionally, an annular sealing element is formed between the cylindrical sliding element and the tubular portion in order to ensure sealing for the hydraulic liquid during a displacement of the sliding element.

In further exemplary embodiments, the connecting part comprises at least one protective cap which is configured to protect the closure from dust and/or from undesired severing. The protective cap can, for example, contain a material which prevents unintended severing (for example a plastic material).

In further exemplary embodiments, the closure comprises a piston-shaped slide which is movable parallel to the flow direction of the hydraulic fluid and which is pretensioned by a spring element in order to keep the hydraulic connecting duct closed before the connection, for example until such time as the connecting part is connected to the counterpart.

In further exemplary embodiments, the piston-shaped slide comprises at least one opening and is configured to be moved counter to the spring tension during the connection of the connecting part to the counterpart and in so doing expose the at least one opening, with the result that the at least one opening becomes part of the hydraulic flow path.

In further exemplary embodiments, the closure and/or the sealing elements are or is configured to maintain a predetermined oil pressure within the connecting duct before the connection to the counterpart (for example up to 5 bar, 7 bar or up to 10 bar).

In further exemplary embodiments, the fastening arrangement provide a thread-shaped engagement arrangement between the connecting part and the counterpart, with the result that the connecting part and the counterpart approach one another during the connection and the opening arrangement open the closure.

The present invention also relates to a hydraulic counterpart which is configured for connection to the hydraulic connecting part. The counterpart comprises a further hydraulic connecting duct with a further connection opening, a further closure for the further connection opening and at least one further fastening element. The further connection opening faces the connecting part during the connection. The further closure is configured to keep the hydraulic liquid in the further connecting duct. The at least one further fastening arrangement is configured to fasten the counterpart to the connecting part and to keep the hydraulic flow path open.

In further exemplary embodiments, the counterpart additionally comprises a (step-shaped) stop region which forms a stop and is formed at a position in the counterpart, with the result that, during the connection of the connecting part to the counterpart, the sliding element of the connecting part butts against the stop region and subsequently moves relative to the tubular portion. Optionally, the further closure comprises a further covering which is arranged in such a way that, during the connection, the opening arrangement of the connecting part sever the further covering.

In further exemplary embodiments, the further closure comprises a stop element, a sliding element and a further spring element, wherein the further spring element sealingly presses the sliding element under a pretensioning against the stop element. The sliding element is formed for example in order to be displaced against the spring tension during the connection and at the same time to expose the further hydraulic connection duct.

In further exemplary embodiments, the counterpart comprises at least one flat seal which is formed on the stop region or in a bottom region of the counterpart in order to achieve fluid sealing between the stop portion and the sliding element. An advantage of this embodiment consists in the fact that the stop can be dispensed with since the flat seal itself can form the stop. Moreover, the wear of the sealing element in a flat seal is minimized and the reliability is increased.

The present invention also relates to a quick connector having a hydraulic connecting part and a hydraulic counterpart, as have been described above. The present invention also relates to a commercial vehicle having the quick connector. For example, the quick connector can be used for connection between a steering gear and a hydraulic module. However, the invention is not intended to be limited to this specific application.

Exemplary embodiments achieve the aforementioned technical object by specifically configured closures which are present on the hydraulic subcomponents and which allow filling with hydraulic oil already prior to assembly (for example by a supplier). In a final assembly stage of a vehicle, the individual components can then be assembled in a simple manner. Exemplary embodiments thus achieve the following advantages: a simple handling is possible during installation and a final filling of the systems with oil is not required, which offers significant advantages for quick assembly. Since oil is already present in the connecting parts, there is no risk of contamination and the entry of air during coupling can be minimized. Since the two components can already be filled with oil by a supplier prior to the final assembly stage of the vehicle, the final assembly stage of the vehicle can be made more efficient.

Exemplary embodiments of the present invention are thus able to be used in particular as single-use connectors for quick assemblies of hydraulic components in series production, wherein any desired hydraulic components can be connected with the quick connector according to exemplary embodiments of the present invention.

The exemplary embodiments of the present invention will be better understood by way of the following detailed description and the appended drawings of the different exemplary embodiments which should not be understood, however, such that they restrict the disclosure to the specific embodiments, but merely serve for explanation and for understanding.

### BRIEF DESCRIPTION OF THE DRAWINGS

FIG. 1 shows a hydraulic connecting part and a counterpart according to one exemplary embodiment of the present invention.

FIG. 2 shows a further exemplary embodiment of the connecting part and the counterpart.

FIGS. 3A, 3B and 3C illustrate the steps of the hydraulic connection for a quick connector according to the present invention.

FIGS. 4A, 4B and 4C illustrate the steps of the hydraulic connection for the quick connector according to a further exemplary embodiment.

FIGS. 5A, 5B and 5C illustrate the steps of the hydraulic connection for the quick connector according to a further exemplary embodiment.

FIG. 6 shows a further exemplary embodiment for connecting the connecting part and the counterpart.

### DETAILED DESCRIPTION

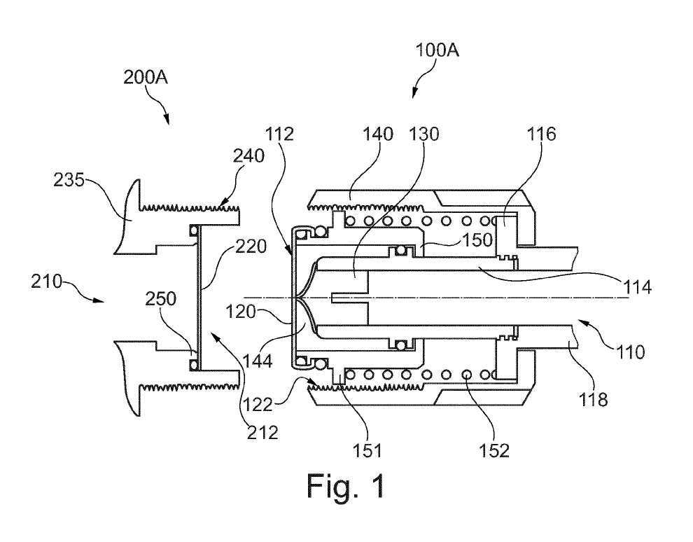

FIG. 1 shows a hydraulic connecting part 100A and a counterpart 200A. The hydraulic connecting part 100A is configured to allow a connection to the counterpart 200A. Equally, the counterpart 200A is adapted to the connecting part 100A in order to allow a connection. The connecting part 100A and the counterpart 200A form, for example, a quick connector to produce a hydraulic flow path between the hydraulic connecting part 100A and the counterpart 200A.

The hydraulic connecting part 100A comprises a hydraulic connecting duct 110 having a connection opening 112 and fastening arrangement 140. The connection opening 112 faces the counterpart 200A during the connection and the fastening arrangement 140 are configured to fasten the connecting part 100A to the counterpart 200A. The hydraulic connecting part 100A further comprises a closure 120 for the connection opening 112, wherein the closure 120 is configured to keep a hydraulic liquid (not shown in FIG. 1) in the hydraulic connecting duct 110 at a minimum pressure. The hydraulic connecting part 100A additionally comprises opening arrangement 130 which are configured to open the closure 120 during the connection of the connecting part 100A to the counterpart 200A in order thus to form the hydraulic flow path along the hydraulic connecting duct 110.

The hydraulic counterpart 200A is configured for connection to the hydraulic connecting part 100A and comprises a further hydraulic connecting duct 210 having a further connection opening 212 which faces the connecting part 100A during the connection. The counterpart 200A additionally comprises a basic body 235 which defines the connection opening 212, and a further closure 220 for the connection opening 212, wherein the further closure 220 is configured to keep a hydraulic liquid (not shown in FIG. 1) in the further connecting duct 210. The counterpart 200A additionally comprises at least one further fastening element 240 which is configured to connect the counterpart 200A to the connecting part 100A.

The term “opening” or “connection opening” is intended to be interpreted broadly and not to be limited to the “opening” always having to be open. Rather, what is to be understood by “opening” is a region which, although it can be temporarily closed (for example by a closure), can be opened by “opening arrangement” and thus allows at least one open state.

In the exemplary embodiment shown, the hydraulic connecting duct 110 of the connecting part 100A is formed by a tubular portion 114, and the opening arrangement 130 are fastened to the connection opening 112 of the tubular portion 114. The exemplary embodiment additionally comprises a cylindrical sliding element 150 which is arranged so as to be displaceable with respect to a longitudinal direction along the tubular portion 114. The closure 120 is fastened to a front end of the sliding element 150, wherein the front end can be defined as an inlet or outlet opening for the hydraulic liquid 10 between the connecting parts. A pipe or hose outlet can be formed on a rear end 118 (opposite to the front end), which outlet is connected, for example, to a hydraulic module or another component (not shown).

The siding element 150 is pretensioned by a first spring element 152, with the result that an interspace 114 is formed between the closure 120 and the opening arrangement 130. The first spring element 152 can be configured, for example, as a compression spring which extends between a projection 151 of the sliding element 150 and a projection 116 of the tubular portion 114, with the result that the sliding element 150 is pressed along the tubular portion 114 in the direction of the connection opening 112.

Moreover, in the exemplary embodiment of FIG. 1, the fastening arrangement 140 is configured, for example, as a screw element (for example a union nut) having an internal thread 122 which engages behind the projection 116 of the tubular portion 114 and extends away from the rear end 118 in a cylindrical shape around the sliding element 150 and the tubular portion 114, in order to move the tubular portion 114 in the direction of the counterpart 200A during the connection of the connecting part 100A to the counterpart 200A.

At the same time, the counterpart 200A offers a stop 250 for the sliding element 150 of the connecting part 100A, with the result that, upon connection of the connecting part 100A to the counterpart 200A, the sliding element 150 butts against the stop 250 (or stop region) and, during the connection, is pressed back in the opposite direction (toward the rear end 118) counter to the spring tension. In addition, the closure can be configured as a covering 120. In a similar manner, the further closure 220 can be configured as a further covering on the stop 250. The coverings 120, 220 can, for example, take the form of a foil or membrane consisting of a plastic material or a metal material (also as metal cover or sheet metal cover).

The connection can occur, for example, by engagement of the screw-form fastening element 120 (with the threaded potion 122) in a corresponding external thread as further fastening arrangement 240, during which time the covering 120 remains in (direct) contact with the further covering 220. As a result, the entry of air is kept low during the connection. This further leads to the fact that the interspace 144 between the opening arrangement 130 and the closure 120 is reduced and subsequently the opening arrangement 130 open the closure 120 and also the further closure 220 of the counterpart 200A. Consequently, the fluid flow path is opened along the connecting duct 110 of the connecting piece and along the connecting duct 210 in the counterpart.

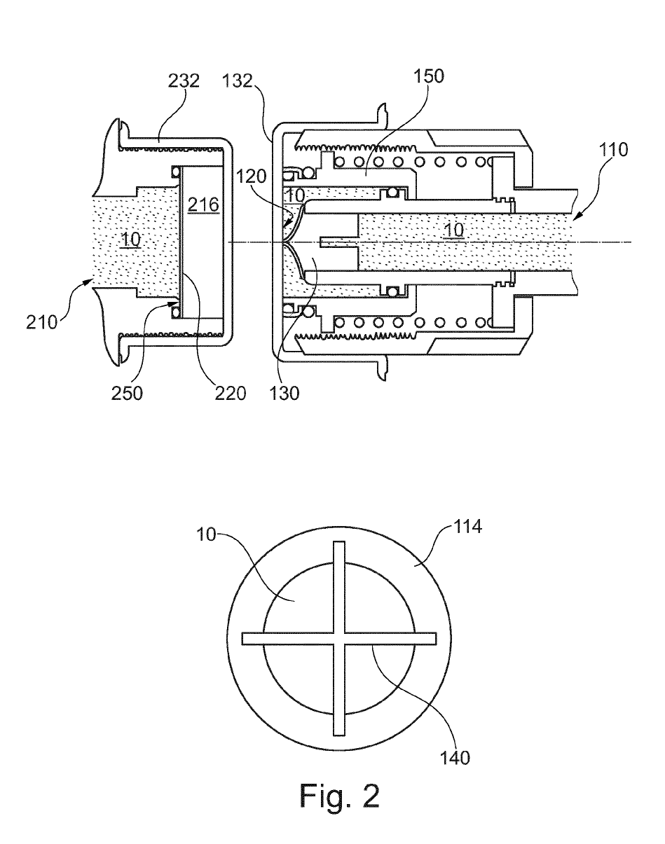

FIG. 2 shows further optional details of the exemplary embodiment from FIG. 1. In this exemplary embodiment, the connecting part 100A and the counterpart 200A are filled with a hydraulic liquid 10. The hydraulic liquid 10 is kept within the connecting ducts 110, 210 by the closure 120 of the connecting part 100A or by the further closure 220 of the counterpart 200A. Here, the closures 120, 220 are configured in such a way that the hydraulic liquid 10 can be kept at a minimum pressure within the connecting ducts 110, 210.

Moreover, in the exemplary embodiment of FIG. 2, the connecting part 100A optionally comprises a protective cap 132 and the counterpart 200A optionally comprises a further protective cap 232. The protective caps 132, 232 serve, for example, to protect the closures 120, 220 in order to prevent unintended severing of the closures 120, 220 but also to avoid penetration of dust. For this purpose, the protective caps 132, 232 can be configured with sufficient stability (for example as plastic bodies or metal bodies) in order to ensure reliable protection. Optionally, an air-filled depression 216 can be formed between the further protective cap 232 of the counterbody 200A and the further closure 220. This depression 216 offers the advantage that the external thread of the fastening element 240 of the counterpart 200A projects further in the direction of the connecting part 100A in order thus to achieve an early engagement of the fastening arrangement 120, 220, to be precise before the two closures 120, 220 come into contact with one another during the connection. As a result, the closures 120, 220 need to be opened only when the fastening arrangement 140, 240 have already come into engagement with one another and the possible pressure of the hydraulic liquid 10 acts.

FIG. 2 additionally shows, at the bottom, a cross-sectional view perpendicular to the flow direction of the hydraulic liquid 10 through the connecting duct 110, to be precise in the vicinity of the connection opening 112 through the opening arrangement 130. As the cross-sectional view shows, the opening arrangement 130 are configured as a cruciform blade within the tubular portion 114. Here, the opening arrangement 130 of blade-like design have openings through which the hydraulic liquid 10 can flow from the connecting duct 110 toward the counterpart 200A (or in the opposite direction). The blade-like opening arrangement 130 can have, for example, as can be seen in FIG. 2 at the top, a conical shape with a point, with the result that the point of the conical opening arrangement makes it easier to sever the closure 120 configured as a covering. By tightening the exemplary union nut as fastening element 140, the exemplary cruciform blade cuts through the two coverings 120, 220 and bends the resulting (four) wings to the side, with the result that the tubular portion 114 can be guided through the two coverings 120, 220. The blade-like opening arrangement 130 shown are particularly advantageous when the coverings 120, 220 are of stable design, in order, for example, to be able to withstand a minimum pressure of for example 7 bar or more. If the closures 120, 220 are formed, for example, as a plastic film or metal foil, the blade-like opening arrangement 130 described, which can, for example, likewise contain a metal, can easily sever the closures 120, 220.

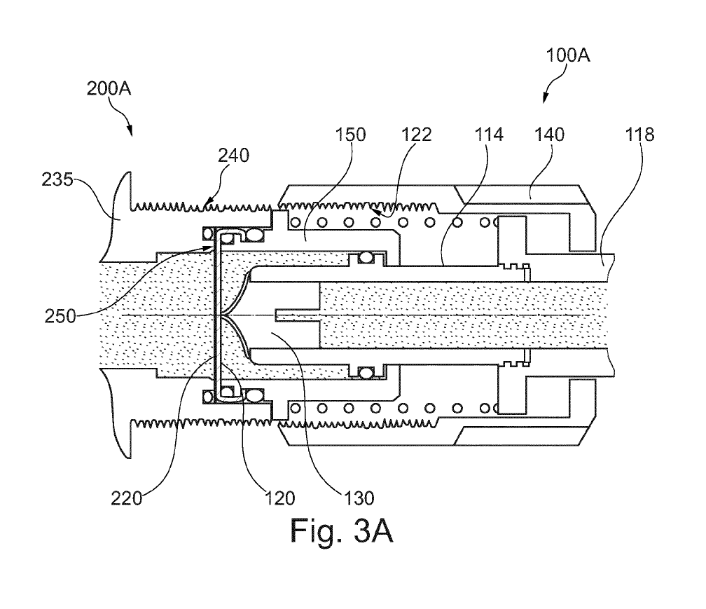

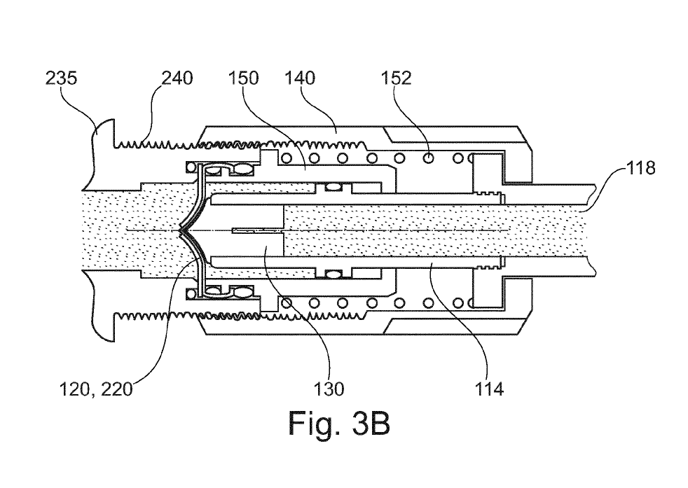

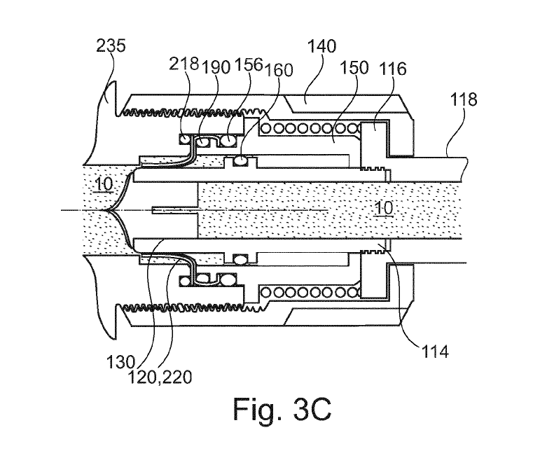

FIGS. 3A to 3C show the individual steps of connecting the connecting part 100A to the counterpart 200A. First of all, the protective caps 132, 232 are removed from the connecting part 100A and from the counterpart 200A (see FIG. 2). The connecting part 100A can then be inserted into the resulting depression 216 in the counterpart 200A by way of the sliding element 150. The depression 216 is formed to fit with the sliding element 150.

The internal thread 122 of the fastening element 120 and the external thread of the basic body 235 do not yet need to engage in one another at this moment. For this purpose, the exemplary union nut 140 can be pushed back. The connecting part 100A can be inserted so far into the depression 216 until the closures 120, 220 abut (see FIG. 3A). At this moment, the stop 250 blocks the sliding element 150 which, during the progressive connection of the connecting part 100A to the counterpart 200A, moves in the direction of the rear end 118 (to the right in FIG. 3A).

FIG. 3B shows the next step in which the exemplary union nut 140 is screwed by its internal thread 122 onto the external thread of the basic body 235. Since the sliding element 150 is blocked by the stop 250 in the longitudinal direction, it slides in the direction of the rear end 118 counter to the spring tension of the first spring element 152. At the same time, the tubular portion 114 moves further into the counterpart 200A until the opening arrangement 130 butt against the closures 120, 220 and sever (or pierce through) the latter. As a result, the connecting duct 110 comes into fluidic connection with the further connecting duct 210 of the counterpart 200A. The hydraulic liquid 10 can pass through the openings, which the opening arrangement 130 free in the cross section of the connecting duct 110 (see cross-sectional view in FIG. 2, bottom), from the connecting duct 110 into the further connecting duct 210 of the counterpart 200A (or vice versa).

FIG. 3C shows the conclusion of the connection of the connecting part 100A to the counterpart 200A. In this conclusion stage, a rear portion of the sliding element 150 comes into butting contact with the projection 116 of the tubular portion 114. As a result, the sliding element 150 cannot be pressed further rearward, in the direction of the rear end 118, and the exemplary union nut 140 can thus be firmly tightened. In this stage, the closures 120, 220 are also completely severed by the opening arrangement 130, and the tubular portion 114 has passed (completely) through the closures 120, 220. There is thus a fluid connection between the connecting duct 110 of the connecting part 100A and the connecting duct 210 of the counterpart 200A.

Since, prior to the assembly of the connecting part 100A with the counterpart 200A, it is possible, for example, for hydraulic oil 10 to be situated in the connecting duct 110 and also in the further connecting duct 210 under an (over)pressure, sealing elements are formed at various points. They are intended to prevent a situation in which the hydraulic liquid 10 can escape during the connection (but also before or after). For example, an annular sealing element 160 is formed between the tubular portion 114 and the sliding element 150. It prevents hydraulic liquid 10 from being able to flow along an outer surface of the tubular portion 114 from the connection opening 112 toward the rear end 118. The sealing element 160 is advantageously configured to be annular in a groove extending along the outer circumferential direction of the tubular portion 114. In this way it is possible, during the movement of the sliding element 150, for the sealing element 160 to move in a rolling manner in order thus to reduce wear.

Moreover, a further annular sealing element 218 is present between the further closure 220 of the counterpart 200A and the basic body 235 or the stop 250. A further annular sealing element 190 is arranged between the closure 120 of the connecting part 100A and the sliding element 150. The pressure which is exerted by the first spring element 152 simultaneously ensures that the sealing elements 218, 190 are under tension and thus ensure reliable sealing. Finally, an annular sealing element 156 can likewise be formed in a groove along the outer circumference of the sliding element 150, said sealing element ensuring sealing between the sliding element 150 and the counterpart 200A.

The exemplary embodiment which has been described by FIGS. 1 to 3C constitutes one form of a single-use connector for a quick assembly of hydraulic components in a series production. The hydraulic liquid 10 (for example oil) can be present in the connecting part 100A during the quick assembly at a pressure of for example about 7 bar (or at most 10 bar, 7 bar or at most 5 bar). The hydraulic oil 10 in the further connecting duct 210 of the counterpart 200A can also be under a pressure (at most 10 bar, at most 7 bar or at most 5 bar), but it can also be pressureless. Therefore, the hydraulic unit, which can be connected to the rear end 118, can be prefilled with oil, wherein an expansion vessel can prevent an overpressure. The steering gear, which is coupled for example to the counterpart 200A, can likewise already be prefilled with oil 10. It will be understood that the invention does not depend on which component is coupled to which side. In further exemplary embodiments, a steering gear can be coupled to the rear end 118 of the connecting part 110A and a hydraulic module can be coupled to the counterpart 200A. There is also no need for an overpressure to be formed. Rather, a partial vacuum can also be present as protection from overpressure during the mounting. The connection pipes or connection hoses on the rear end 118 can, for example, already have been connected on one side to one of the hydraulic components.

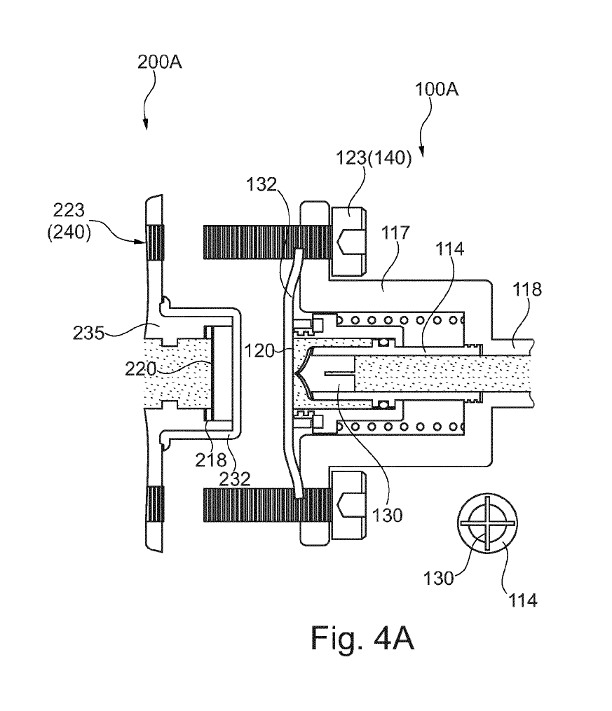

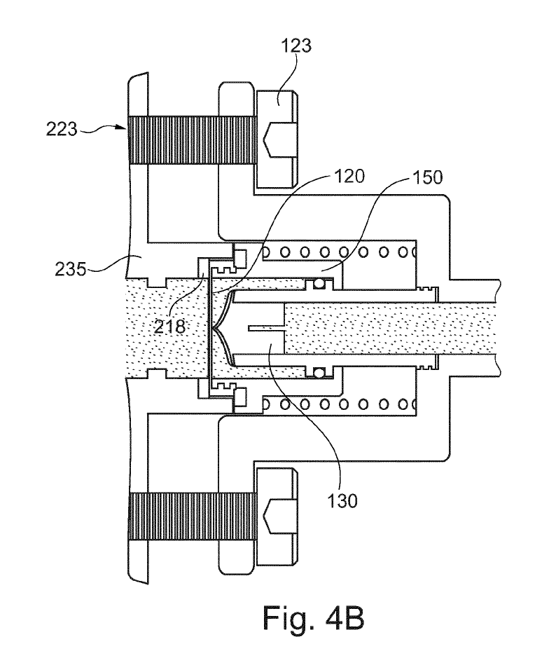

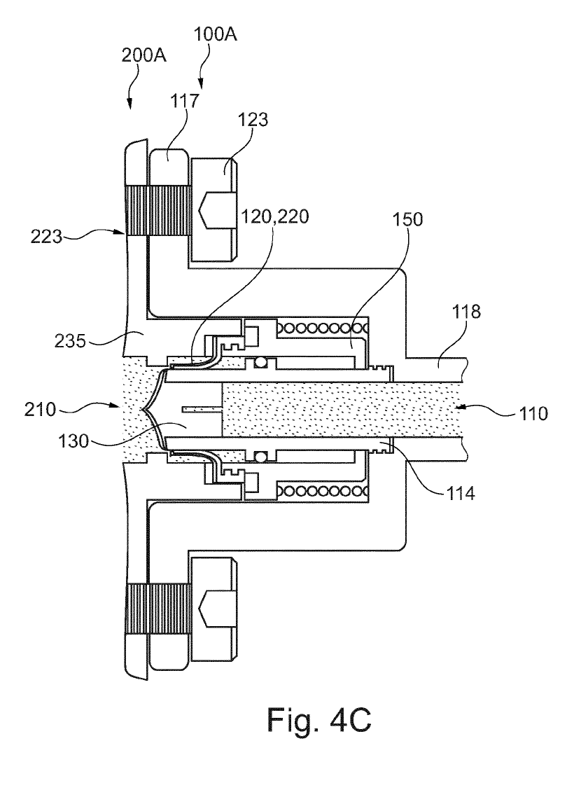

FIGS. 4A to 4C show a further exemplary embodiment of the present invention, in which, apart from the fastening arrangement 123(140), 223 (240) and the sealing elements 218, 156, the connecting part 100A and the counterpart 200A can be configured identically to the exemplary embodiment shown in FIGS. 1 to 3C.

The fastening arrangement 140 in the exemplary embodiment shown comprise, for example, two bolt elements 123 (Allen screws) which engage in a threaded opening 223 of the basic body 235 and, via a holder 117 (for example in the form of a stirrup or cylinder), press the tubular portion 114 of the connecting part 100A against the counterpart 200A. As also in FIG. 2, protective caps 132, 232 for protecting the closures 120, 220 can be formed on the connecting part 100A and on the counterpart 200A. Here, the protective caps 132, 232 again close the connecting part 100A and the counterpart 200A which are coupled to one another during the formation of the connection. The protective caps 132, 232 can again contain a plastic or a metal or be configured to be sufficiently strong or thick to prevent unintended damage to the closures 120, 220.

FIG. 4A again shows the starting point with the protective caps 132, 232. Moreover, FIG. 4A again shows a cross-sectional view of the opening arrangement 130 which, for example, are configured in the same way as the opening arrangement 130 of FIG. 2.

FIG. 4B shows the state when the connecting part 100A is placed, without the protective cap 132, on the counterpart 200A (likewise without further protective cap 232), to be precise to such a degree until the sliding element 150 butts with the closure 120 against the sealing element 218 of flat design. In this state, the Allen screw 123 engages in the internal thread 223 of the counterpart 200A. By tightening the exemplary two Allen screws 123 of the quick connector 100A, 200A, the cruciform blade (opening arrangement 130) cuts through the two membranes (closures 120, 220) and bends the resulting membrane remains to the side.

FIG. 4C shows the final state in which the screw connections 123, 223 have been connected to one another to such an extent until the holder 117 of the connecting piece 100A butts against the basic body 235 of the counterpart 200A. This longitudinal movement leads to a situation in which the sliding element 150 moves relative to the tubular portion 114 toward the rear end 118 and at the same time the opening arrangement 130 sever the closures 120, 220 and push the tubular portion 114 through the closures 120, 220. As a result, the fluid connection between the connecting duct 110 and the further connecting duct 210 is established. The opening arrangement 130 can, for example, again be configured as cruciform blades.

The use of the flat seal 218 arrangement that, in this exemplary embodiment, only a minimum air inclusion is possible, which thus increases the reliability of the hydraulic connection. A further advantage of this exemplary embodiment consists in the simple mounting which becomes possible through the use of conventional screws 123.

All further elements are, as stated, formed in the same way as has been shown in the exemplary embodiment of FIGS. 1 to 3C, and therefore a repeated description is not necessary.

In all of the previously shown exemplary embodiments, the closure 120 and/or the further closure 220 are or is fastened to the sliding element 150 or the basic body 235 (for example as membrane), for example via grooves, depressions or a thread, and are or is damaged during the production of the hydraulic connection. However, the invention is not limited to such single-use connectors.

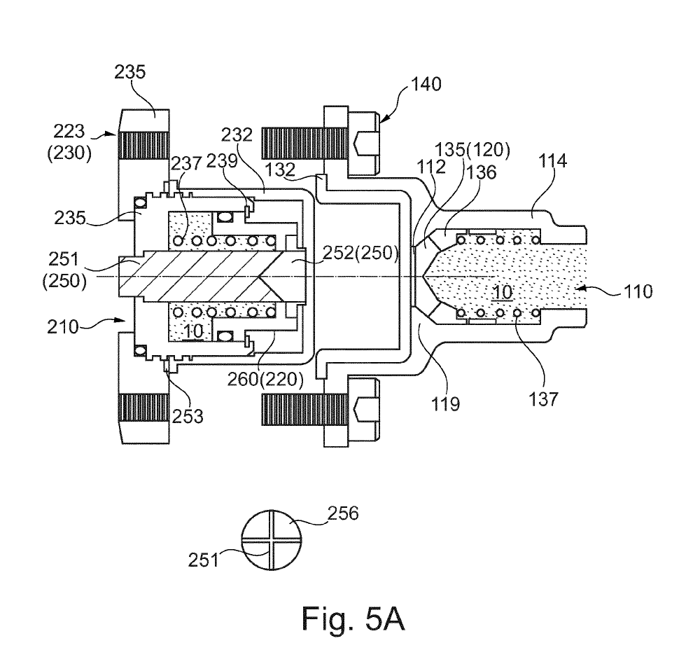

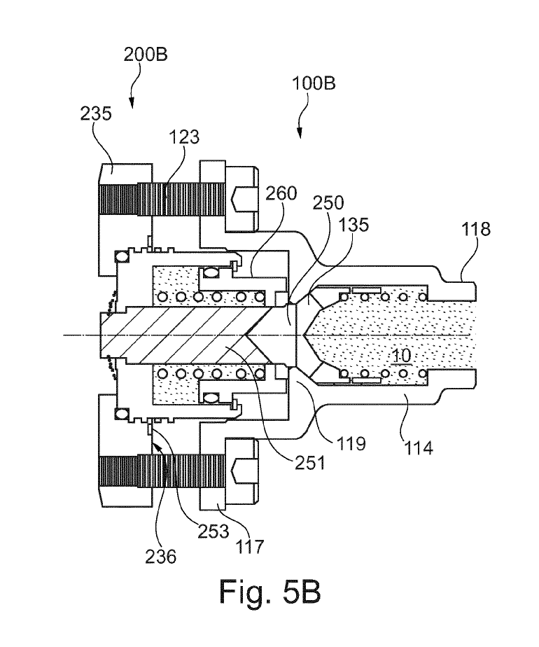

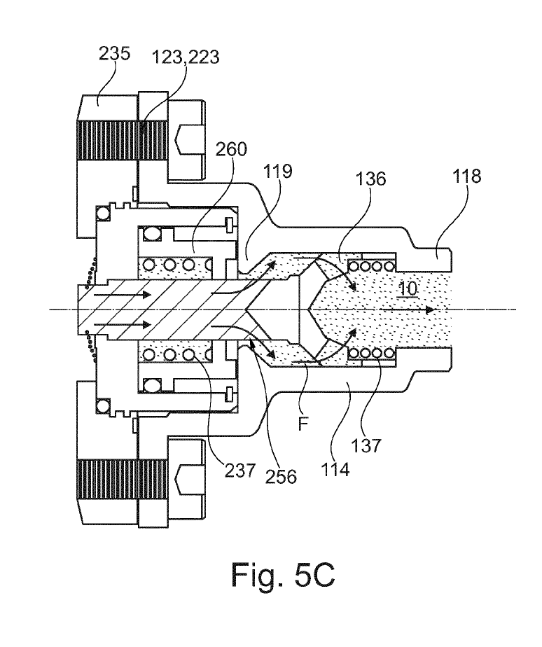

FIG. 5A to 5C show a further exemplary embodiment of the present invention for the quick connector having a hydraulic connecting part 100B and a counterpart 200B which can be used multiple times for opening and for closing without damaging the closure (multi-use connector). The hydraulic connecting part 100B again comprises a hydraulic connecting duct 110, a closure 120 and fastening arrangement 140. The hydraulic connecting duct 110 is again filled with a hydraulic liquid 10, for example.

In the exemplary embodiment shown, the closure 120 comprises a (piston-shaped) slide 135 with laterally formed openings 136. The slide 135 is pretensioned by a further spring element 137 in order to close the connection opening 112 of the connecting duct 110 by the slide 135 (no openings 136 are formed in the region of the connection opening 112). For this purpose, in the exemplary embodiment shown, the closure 120 is partially formed as a truncated cone which butts against a beveled projection 119 of the tubular portion 114 and thus tightly closes off the laterally formed openings 136 and also the connection opening 112 of the connecting duct 110.

Moreover, the exemplary embodiment comprises a protective cap 132 for the connection opening 112 of the connecting part 100B, which is configured to protect the connection opening 112 from unintended opening (for example by a sliding-back of the slide 135 into the connecting duct 110). To seal the connecting duct 110, an annular sealing element is incorporated in the slide 135, opposite the beveled projection 119. Moreover, the exemplary embodiment comprises fastening arrangement 140 which, as in FIG. 4, can be configured as screw elements 123 (for example Allen screws) in order to fix the connecting part 100B on the counterpart 200B.

However, in the exemplary embodiment shown here, no opening arrangement is necessary. Rather, the slide 135 is pushed back by the interaction with the counterpart 200B and the connecting duct 110 consequently opened.

The counterpart 200B again comprises a further hydraulic connecting duct 210, a further closure 220 and a stop element 250. In the exemplary embodiment shown, the further closure 220 comprises a further sliding element 260 of annular design which extends for example as an annular piston around the stop element 250 and is displaceable relative thereto. In addition, the counterpart 200B comprises further fastening elements 223 (230) which can again be formed as an internal thread part 223 in order to receive the exemplary Allen screws 123 of the connecting part 100B. In this exemplary embodiment, the stop element 250 is fastened immovably to the counter body/basic body 235 and the further sliding element 260 is arranged so as to be displaceable relative to the basic body 220 within a cylindrically formed depression of the basic body 220.

The stop element 250 has a first portion 251 and a second portion 252, wherein the first portion 251 is shown as a cross-sectional view (perpendicular to the further connecting duct 210) in the image at the bottom in FIG. 5A. A further spring element 237 pretensions the further sliding element 260, with the result that it presses against the second portion 252 of the stop element 250 and produces a fluid-tight connection with the stop element 250. In the first portion 251 there are formed openings 256 through which the hydraulic liquid 10 can flow along the further connecting duct 210. However, no openings are formed in the second portion 252, with the result that the sliding element 260 can close the connecting duct 210. A hydraulic liquid 10 can therefore still be kept within the further fluid duct 210 prior to assembly. In order to improve the sealing, it is also optionally possible for this purpose for the cylindrically formed portion of the basic body 235 to have a sealing stop 239 against which the further sliding element 260 is pressed by the further spring 237.

Moreover, the counterpart 200B from the exemplary embodiment of FIG. 5A can also again comprise a protective cap 232 in order to prevent a situation in which the further sliding element 260 is pressed back in an unintended manner counter to the spring tension and thus hydraulic liquid 10 could escape from the interior of the connecting duct 210. The protective caps 132, 132 can again contain a material which offers reliable protection (for example a plastic material with sufficient strength), with the result that the connecting ducts 110, 210 are not opened in an unintended manner.

FIGS. 5B and 5C illustrate the process of the connection of the connecting part 100B to the counterpart 200B.

In FIG. 5B there is shown at first the process step in which the protective caps 132, 232 have been removed and the connecting part 100B has been placed on the counterpart 200B. The connection opening 112 of the connecting piece 100B (see FIG. 5A) has, for example, an opening region which can receive the stop element 250. In addition, the projection 119 is arranged on the tubular portion 114 in such a way that, after the connecting part 100B has been placed on the counterpart 200B, the projections 119 butt against the further sliding element 260. For example, the stop element 250 can project out in front of the sliding element 260 and at the same time the connection opening 112 can have a depression, wherein the depression can have a depth identical to the height of the projection of the stop element 250 (see FIG. 5A). Therefore, when placing the connecting part 100B on the counterpart 200B, the stop element 250 is inserted into the depression. At (approximately) the same time, the projection 119 butts against the sliding element 260 and a surface of the stop element 250 butts against the piston-shaped slide 135.

Subsequently thereto, the connecting part 100B is moved further in the direction of the counterpart 200B (see FIG. 5C). This results in the slide 135 being pressed counter to the spring tension of the spring element 137 in the direction of the rear end 118, while at the same time the further sliding element 260 of the counterpart 200B is likewise pressed counter to the spring tension of the spring element 237 toward the basic body 235 by the projection 119. The openings 136 of the slide 135 and the openings 256 of the stop element 250 (see also FIG. 5A, bottom) are thus exposed and the fluid flow F (see FIG. 5C) is established. The hydraulic liquid 10 can thus flow from the counterpart 200B to the connecting part 100B along the flow path F, to be precise can first pass through the openings 256 of the stop element 250, then into the interior of the tubular portion 114 of the connecting part 100B and finally, via the openings 136 of the slide 135, toward the rear end 118 of the connecting part 100B (or in the opposite direction).

Finally, the fastening elements (i.e. the screw connections 123, 223) can be screwed together and produce a firm connection between the connecting part 100B and the counterpart 200B. As also in the embodiments of FIGS. 4A to 4C, it is also possible, in the exemplary embodiment of FIGS. 5A to 5C, for an annular flat seal 253 to be formed on a bottom region 236 of the basic body 235 (see FIG. 5B), which achieves additional sealing between the basic body 235 of the counterpart 200B and the holder 117. The holder 117 again serves for fastening the connecting part 100B and can be formed in one piece with the tubular portion 114 in this exemplary embodiment.

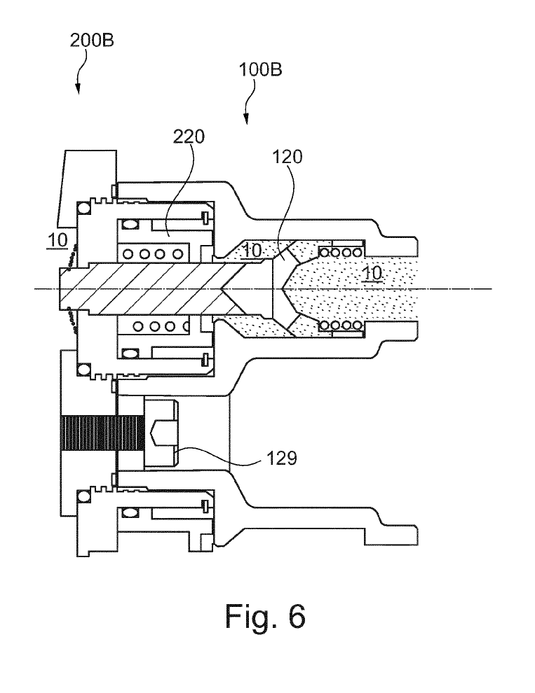

FIG. 6 shows a further exemplary embodiment in which the connecting part 100B and the counterpart 200B are constructed in the same manner as is shown in FIGS. 5A to 5C. However, in this exemplary embodiment, a plurality of connecting parts 100B are fastened to one (or more) counterparts 200B by a common fastening element 129 (for example a common screw connection). All further elements are formed in the same way as has been described in the exemplary embodiment of FIGS. 5A to 5C, and therefore a repeated description is not necessary.

The embodiments of FIGS. 5A to 5C and 6 are suitable for quick assembly of hydraulic components in a series production. In particular, these embodiments offers the advantage that multiple connection and multiple separation of the hydraulic component is possible, for example in the case of a repair. If namely the fastening elements 140, 240 are released, both the closure 120 in the connecting part 100B and the closure 220 in the counterpart 200B close on account of the spring tensions and the state, as is shown in FIG. 5A, is achieved again.

Moreover, this exemplary embodiment also offers the advantage that, by virtue of a prefilling with hydraulic liquid 10, an air inclusion during the connection is minimized. Here, too, the hydraulic liquid 10 can be introduced in the connecting part 100B under a pressure of for example about 5 bar (or any other desired pressure). In the counterpart 200B there can, but need not, bear an overpressure for the hydraulic liquid 10 (a vacuum can also be formed there). The exemplary embodiment of FIG. 6 additionally offers the advantage that the fastening is achieved only by a central fastening screw 129, thereby allowing simple assembly during series production and also during repair.

Consequently, the hydraulic connections can be quickly released and also re-established. However, the screw connections shown constitute only one possibility which allows secure and firm fastening of the connecting part 100A, 100B to the counterpart 200A, 200B. However, the invention is not intended to be limited to the screw-type connection. Any other desired fastening possibility is also intended to be encompassed (for example rivet connection, clamping connections or any other desired force- or form-fitting form of connection).

Although the invention is not intended to be limited thereto, a particular exemplary embodiment can be applied for the electrohydraulically operated steering system of a commercial vehicle (for example a truck), wherein, for example, a steering gear are connected to a hydraulic module or to a cylinder of a further steerable axle via the hydraulic connection. Of course, exemplary embodiments can also be applied to all further hydraulic components in vehicles. When using the hydraulic connector according to the present invention, the hydraulic module of a commercial vehicle can be mounted at a suitable point, to be precise independently of the position of the exemplary steering gear or of another hydraulic module which is intended to be operated by the hydraulic module. In order to increase the variety of variants, it is possible, for example in the case of a nonrequired cylinder for a second steering axle, in place of the basic body 235, also to use a closure plug for a permanently nonrequired quick coupling.

The features of the invention which are disclosed in the description, the claims and the figures may be essential both individually and in any desired combination for implementing the invention.

### LIST OF REFERENCE SIGNS

10 Hydraulic liquid
100A,B Hydraulic connecting part
110, 210 Hydraulic connecting ducts
112, 212 Connection openings
114 Tubular portion
116, 151 Projections
117 Holder
118 Rear end
120, 220 Closures
122 Thread
123, 223 Screw connection
130 Opening arrangement
132, 232 Protective caps
135 Piston-shaped slide
136, 256 Openings
137, 152, 237 Spring elements
140, 240 Fastening arrangement
144 Interspace
150 Sliding element
156,160,190,218 Annular sealing elements
200A,B Hydraulic counterpart
216 Depression
235 Basic body
236 Bottom region
239 Sealing stop
250 Stop region or stop element
251, 252 First and second portion of the stop element
253 Flat sealing element
260 Further slide, sliding element

1-15. (canceled)

16. A hydraulic connecting part for connecting to a hydraulic counterpart to form a hydraulic flow path between the hydraulic connecting part and the counterpart, comprising:
a hydraulic connecting duct having a connection opening which faces the counterpart during the connection;
a closure for the connection opening to keep a hydraulic liquid in the hydraulic connecting duct at a minimum pressure; and
a fastening arrangement to fasten the connecting part to the counterpart.

17. The hydraulic connecting part of claim 16, further comprising:
an opening device to open the closure during the connection of the connecting part to the counterpart, so as to form the hydraulic flow path.

18. The hydraulic connecting part of claim 17, wherein the closure includes a covering, in particular a metal membrane, and a sliding element, wherein the sliding element is pretensioned via a first spring element so as to ensure an interspace between the opening device and the covering and to sever the covering by opening device during a displacement of the sliding element counter to the spring tension.

19. The hydraulic connecting part of claim 18, wherein the hydraulic connecting duct is formed within a tubular portion, wherein the sliding element is displaceable along an outer surface of the tubular portion, and wherein the opening device includes at least one cutting blade which is formed at one end in the direction of the connection opening of the tubular portion in the hydraulic flow path.

20. The hydraulic connecting part of claim 19, wherein the sliding element has a cylindrical configuration and a groove with a first annular sealing element along its outer circumference so as to allow sealing between the counterpart and the connecting part after the connection, and wherein an annular sealing element is formed between the cylindrical sliding element and the tubular portion so as to ensure sealing for the hydraulic liquid during a displacement of the sliding element.

21. The hydraulic connecting part of claim 16, wherein the closure includes a piston-shaped slide which is movable parallel to the flow direction of the hydraulic liquid and which is pretensioned by a spring element to keep the hydraulic connecting duct closed before the connection.

22. The hydraulic connecting part of claim 21, wherein the piston-shaped slide has at least one opening and is configured to be moved counter to the spring tension during the connection of the connecting part to the counterpart so as to expose the at least one opening, so that the at least one opening becomes part of the hydraulic flow path.

23. The hydraulic connecting part of claim 16, wherein the closure and/or the sealing elements are configured to maintain a predetermined oil pressure within the connecting duct before the connection to the counterpart.

24. The hydraulic connecting part of claim 16, wherein the fastening device has a thread-shaped engagement device between the connecting part and the counterpart, so that the connecting part and the counterpart approach one another during the connection and the opening device open the closure.

25. A hydraulic counterpart for connecting to a hydraulic connecting part, comprising:
a further hydraulic connecting duct having a further connection opening which faces a hydraulic connecting part during the connection, wherein the hydraulic connecting part for connecting to the hydraulic counterpart forms a hydraulic flow path between the hydraulic connecting part and the counterpart, including: a hydraulic connecting duct having a connection opening which faces the counterpart during the connection; a closure for the connection opening to keep a hydraulic liquid in the hydraulic connecting duct at a minimum pressure; and a fastening arrangement to fasten the connecting part to the counterpart;
a further closure for the further connection opening to keep the hydraulic liquid in the further connecting duct; and
at least one further fastening element to fasten the counterpart to the connecting part.

26. The counterpart of claim 25, further comprising:
a stop, which is formed at a position in the counterpart, so that, during the connection of the connecting part to the counterpart, the sliding element of the connecting part butts against the stop and subsequently moves relative to the tubular portion, wherein the further closure includes a further covering which is arranged so that, during the connection, the opening device of the connecting part severs the further covering.

27. The counterpart of claim 25, wherein the further closure has a stop element, a sliding element and a further spring element, wherein the further spring element sealingly presses the sliding element under a pretensioning against the stop element, and wherein the sliding element is configured to be displaced against the spring tension during the connection and at the same time to expose the further hydraulic connecting duct.

28. The counterpart of claim 26, wherein at least one flat seal formed on the stop or in a bottom region of the counterpart so as to provide fluid sealing between the stop and the sliding element or between a holder of the connecting part and a basic body of the counterpart.

29. A quick connector, comprising:
a hydraulic connecting part; and
a hydraulic counterpart;
wherein the hydraulic connecting part is for connecting to the hydraulic counterpart to form a hydraulic flow path between the hydraulic connecting part and the counterpart, including: a hydraulic connecting duct having a connection opening which faces the counterpart during the connection; a closure for the connection opening to keep a hydraulic liquid in the hydraulic connecting duct at a minimum pressure; and a fastening arrangement to fasten the connecting part to the counterpart; and
wherein the hydraulic counterpart is for connecting to the hydraulic connecting part, including: a further hydraulic connecting duct having a further connection opening which faces a hydraulic connecting part during the connection; a further closure for the further connection opening to keep the hydraulic liquid in the further connecting duct; and at least one further fastening element to fasten the counterpart to the connecting part.

30. A commercial vehicle, comprising:
a quick connector, including:
a hydraulic connecting part; and
a hydraulic counterpart;
wherein the hydraulic connecting part is for connecting to the hydraulic counterpart to form a hydraulic flow path between the hydraulic connecting part and the counterpart, including: a hydraulic connecting duct having a connection opening which faces the counterpart during the connection; a closure for the connection opening to keep a hydraulic liquid in the hydraulic connecting duct at a minimum pressure; and a fastening arrangement to fasten the connecting part to the counterpart; and
wherein the hydraulic counterpart is for connecting to the hydraulic connecting part, including: a further hydraulic connecting duct having a further connection opening which faces a hydraulic connecting part during the connection; a further closure for the further connection opening to keep the hydraulic liquid in the further connecting duct; and at least one further fastening element to fasten the counterpart to the connecting part.
